(19) United States
(12) Patent Application Publication
(10) Pub. No.: US 2008/0249831 A1
(43) Pub. Date: Oct. 9, 2008

(54) Business method and system for sponsoring a special event

(76) Inventor: Silvia Murra Rischmagui, El Paso, TX (US)

Correspondence Address: STRASBURGER & PRICE, LLP, 901 MAIN STREET, SUITE 4400, DALLAS, TX, 75202, US

(21) Appl. No.: 12/080,768

(22) Filed: Apr. 4, 2008

Related U.S. Application Data
(60) Provisional application No. 60/921,694, filed on Apr. 4, 2007.

(51) Int. Cl. G06F 15/02

(52) U.S. Cl. 705/9

(57) ABSTRACT

A business method and system centered on an enabling facility for providing special events includes a central area for observation of the special event by the sponsors of the special event or by those accompanying the attendees to the special event and a plurality of special activity areas. A staff at the enabling facility will introduce and guide the attendees to the selected activities. Also included in the enabling facility is a security system for the special event.

### CROSS REFERENCE TO RELATED APPLICATION

This application claims the benefit of Provisional U.S. Patent Application No. 60/921,694 filed Apr. 4, 2007.

### STATEMENT REGARDING FEDERALLY FUNDED RESEARCH AND DEVELOPMENT

The invention described in this patent application was not the subject of federally sponsored research or development.

### FIELD

The present invention relates to a business method and system centered on an enabling facility which together create a system for sponsoring a special event. More particularly, when used for an event such as a child's birthday party, the business method and system of the present invention centered on an enabling facility removes the burden from parents of preparing for and hosting a special event and allows the parents attending the special event party to enjoy the special event along with the children. In addition, the disclosed business method and system centered on an enabling facility for sponsoring special event may be used to host a special event where the attendees are adolescents or adults.

### BACKGROUND

In recent years, there has been a convergence of three trends. This trend convergence has created a need for the business method and system of the disclosed invention. These three trends are described in the following three paragraphs.

First, events such as birthday parties, particularly children's birthday parties, have trended toward larger and larger celebrations. In some parts of the country, families have spent thousands of dollars for a single special event celebrating a birthday, a graduation, or a church related event such as a confirmation or a bar mitzvah.

Second, many families, particularly those with multiple young children, experience a life style which requires both parents to be employed. Such employment of both parents cuts into the time available to plan, organize and conduct a special event—particularly a large special event of the type envisioned in the preceding paragraph.

Third, because of the growing awareness of attacks on both children and adolescents, parents have become concerned about security and the safety of their children particularly in venues unfamiliar to the parents. Further, there is also the risk that if an attack on a child or an adolescent takes place, the sponsors of the event may be sued for not properly protecting the attendees. Accordingly, the need to provide a secure and safe venue for all attendees at a special event continues to be a growing and important concern for those sponsoring a special event.

While private party venues have existed for many years, most private party venues are simply a large room which may or may not come with a food preparation facility. Some private party venues may include a stage or a dance floor. Most prior art private party venues do not offer party planning assistance, a range of supervised activities for the attendees and a security system. Thus, for a family that is sponsoring a special event such as a child's birthday party, all of the work to create activities and assure adequate security for the event as well as child safety before, during, and after the special event falls back on the sponsors.

Some restaurants, such as those restaurants that serve fast food, to include pizza or hamburgers, have a designated space to accommodate groups. It remains the primary purpose of these restaurants, however, to sell food. Typically, no special services are offered by restaurants for event planning or for security. In some parts of the country, the restaurant may even be a neighborhood bar or tavern where the environment is not conducive for enjoyment by or for the security of children.

Other venues such as theme parks, museums and zoos also provide a venue for groups for the purpose of a party or a celebration. The only activity for the attendees is a visit to the various attractions at the theme park, the museum or the zoo. Multiple activities tailored to the attendees are not provided. Thus, the burden falls back on either the sponsors or those accompanying the attendees to the party to assure that all attendees are entertained. Security, if any, is provided by security personnel employed or hired by the theme park, the museum or the zoo or a contract security officer hired by the sponsor of the event.

Accordingly, there remains a need in the art for a business method and system centered on an enabling facility which provides for a special event that: a) removes from the sponsor of the special event the burden of preparing for and hosting a special event that will become a memorable experience for all attendees; b) that will allow the sponsors of the special event to themselves enjoy the special event, and c) where an environment is provided for the special event in which appropriate security and child safety concerns have been considered and addressed.

### SUMMARY

There is provided by the business method and system centered on an enabling facility of the present invention a combination of elements which enables removal of the sponsor from the preparation for and hosting of a special event, allows the sponsors of the event to enjoy the event, and wherein the special event is conducted in a secure and safe environment.

The enabling facility includes a central area for observing and monitoring of the activities by the sponsor of the special event and those who accompany the attendees to the special event. Also included in the enabling facility are a variety of different areas including: an area for a signature event, an audio isolation area, and one or more specialty activity areas.

Another key component of the present invention is a security system which monitors ingress to the special event, the conduct of the special event and egress from the special event.

### DESCRIPTION OF THE DRAWING FIGURES

A better understanding of the business method and system for providing a special events venue of the present invention may be had from the drawings figures as described in greater detail in the DESCRIPTION OF THE EMBODIMENTS section which follows wherein:

FIG. 1 is a flow chart of the business method of the present invention;

FIG. 2 is a front perspective view of the preferred embodiment of an enabling facility which is a part of the system of the present invention;

FIG. 2A is a plan view of an exemplary car parking system to be used with the preferred embodiment of the enabling facility shown in FIG. 2.

FIG. 3 is a plan view of the interior of the preferred embodiment of the enabling facility shown in FIG. 2 showing four modules or towers;

FIG. 4 is a plan view of the floor plan an exemplary module or tower;

FIG. 5 is an exemplary flow chart for an event taking place in one of the modules or towers shown in FIG. 4;

FIG. 6 is a plan view of the floor plan of an alternate mobile module embodiment; and

FIG. 7 is a plan view of the floor plan an alternate downsized module embodiment.

### DESCRIPTION OF THE EMBODIMENTS

The following description of the business method and system centered on an enabling facility of the present invention will begin with an overview of its general concept in terms of the advantages provided to users by reference to the preferred embodiment. This initial section of the advantages of the disclosed invention will be followed by an expanded description of the invention in terms of a general description of the features offered to the users by the enabling facility. The third section will be a description of an exemplary structure at which the disclosed invention is implemented. The fourth section will describe the disclosed business method. The last section will describe an exemplary birthday party event enabled by the business method and system of the present invention.

Following the description of the preferred embodiment will be a description of two alternate embodiments, the first being a mobile version and the second being a downsized version for use in a location of a predetermined size such as rental space in mall or a commercial retail strip center.

The main advantage of the disclosed business method and system centered on an enabling facility is to create an environment where attendees can experience the fun of a special event and the sponsors can, to whatever extent desired, enjoy the expressions of happiness as well as the looks of surprise and amazement on the faces of the attendees. Both attendees, sponsors and those accompanying the attendees to the special event will leave with a unique memory of the special event. While the business method and system centered on an enabling facility of the disclosed invention can be used for a variety of different events, a child's birthday party is suggested to the reader as a familiar background against which a better understanding may be obtained of the disclosed business method and system taking place in a preferred embodiment of the enabling facility as described below.

It is also an advantage of the disclosed business method and system centered on an enabling facility to free parents from the burden of work and worry associated with preparing for and hosting a special event, such as a birthday party, for children. Providing such advantage includes the following:

1. Removing from parents the burden of planning, preparing for, organizing and hosting a special event either at home or in a rented location.

2. Introducing and guiding the children attending the special event to a variety of activities determined by the sponsors to keep the children active and interested in the variety of activities offered by the enabling facility. Innovation and child safety are essential to execution of the disclosed business method and system centered on the enabling facility.

3. Enabling both children and their parents to participate in a predetermined program which allows a choice of themed games and activities most suitable to the personal preferences of the special event sponsors.

The business method and system of the present invention, as explained herein to illustrate the disclosed invention, is centered on an enabling facility specially designed for holding a special event such as a child's birthday party. The enabling facility is designed to offer those activities associated with a party or special event that will be enjoyed by the attendees. While the preferred embodiment of a large fixed structure is explained below as an enabling facility, those of ordinary skill in the art will understand the present invention may also be enabled using a mobile facility or a smaller facility than used for the preferred embodiment. The mobile facility and the smaller facility are described below as alternate embodiments. The result provided by the disclosed business method and system centered in on enabling facility is a unique experience for both the children and the parents. Special event planning, preparation and hosting tasks are provided; thereby, the parents or sponsors of the special event along with those accompanying the children to the special event will be able to enjoy the special event along with the children attending the special event.

One target market for the disclosed embodiment includes children 2-12 years of age having working parents and/or grandparents. Additionally, businesses, governmental entities and associations such as schools, churches, clubs, day care centers, may also find the disclosed invention useful for sponsoring special events for families with children. Other events may include family reunions.

The enabling facility in which the business method and system of the present invention is implemented is specially designed for secure ingress and egress by children and their families. A closed circuit television camera security system, and a staff trained in first aid along with child safety will give both the parents and the children the confidence that security and child safety will be a primary concern at the time of the special event. With the help of special lighting effects, proper decoration and a trained staff, special events held at the facility will provide a unique experience for the children, for the adults accompanying the children to the event and/or for the sponsors.

A still better understanding of the present invention may be had by taking a closer look at some of the features of the disclosed embodiment of the business method and system centered on an enabling facility of the present invention.

In the disclosed embodiment, based on the example of a child's birthday party, the following features are present:

1. A guided, private children's game show center, with popular forms of entertainment and activities.

2. Security systems for both drop-off of the children before the event and pick-up of the children after the event.

3. A proprietary menu offering healthy, age-appropriate food and drink selections.

4. A 3 to 4 hour, controlled access, special event.

5. Private and secure vehicle parking.

6. Age appropriate indoor and outdoor activities providing year round entertainment.

7. Multiple choices of activities to enable making the event unique or the child being honored.

8. A predetermined cost structure enabling payment options based on the activities selected by the sponsors beginning long before the special event takes place.

Security and child safety are features at the core of the disclosed invention. A security system will be in place to enable monitoring of activities in all areas of the facility. An additional feature is an identification system provided for each child and for each adult. The identification system allows parents to be more confident in the security and provisions for child safety provided at the enabling facility during the special event.

Because of the security features and arrangement of the interior portions of the enabling facility itself, parents will be able to relax, enjoy the event and better experience the enjoyment of their children. The advantage is that parents can see the children play, engage in activities and participate with them as desired—free of work and worry. Specifically the business method and system centered on an enabling facility of the present invention will include features which:

1. Promote the parent-child relationship.

2. Promote creativity, physical, social, emotional development of the children attending the special event.

3. Promote positive values including friendship, ethical behavior, honesty and team work to reinforce the well being of the children attending the special event.

4. Promote good health with a specially-designed menu which focuses on healthy, age-appropriate food to include: kosher food, organically-grown foods, or foods with no preservatives.

5. Promote audio response and motor skill development with a pre-determined selection of background music.

6. Promote visual response by the use of color, lights and special effects.

7. Promote tactile response and creativity through arts and crafts activities.

8. Promote physical fitness by activities and games.

The purpose of the selected exemplary features when placed together in an enabling facility is to free parents from being consumed with preparing for and hosting a special event. Rather, parents will be able to share in both quality time and to share in the happiness of their children during the special event.

Another purpose of the disclosed invention is to satisfy the needs of children for care, education, social time and entertainment. According to the disclosed invention, children may choose from an array of different activities games, shows, prizes, decorations and food at each special event. Such choices will make each special event a unique experience for both parents and their children.

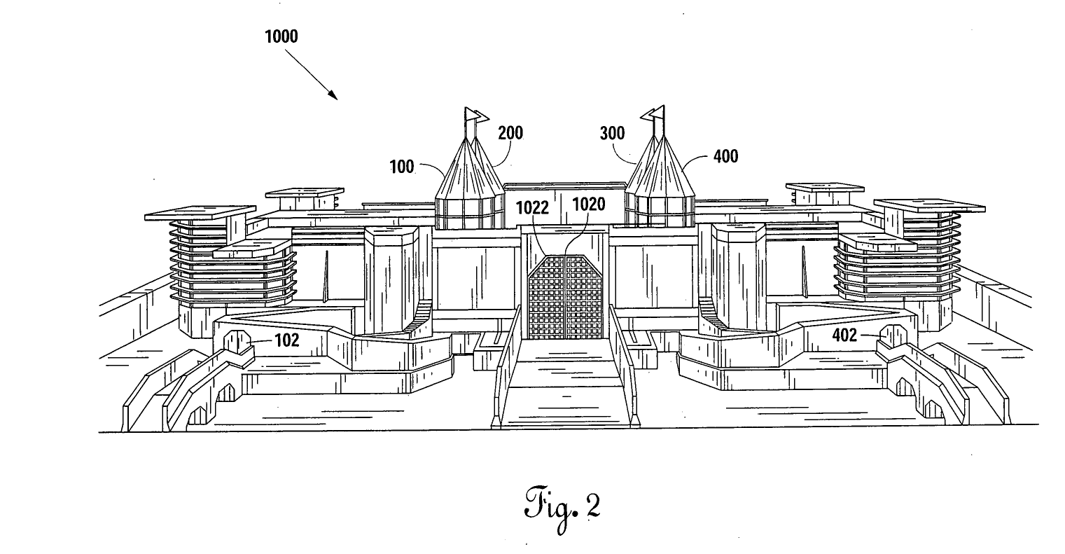

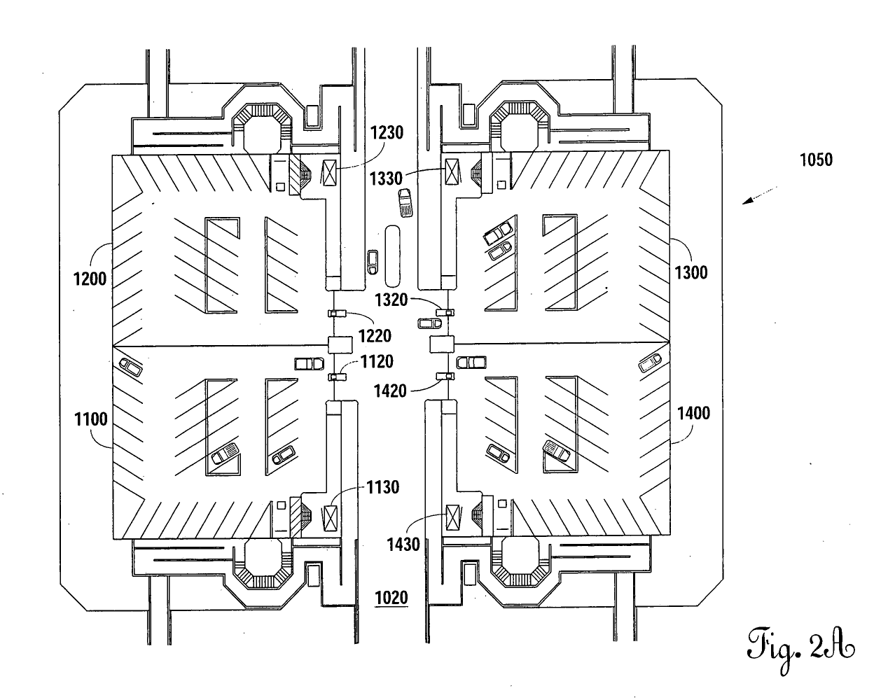

As will be understood by those of ordinary skill in the art, the ability to provide the features listed above requires an enabling facility. While the enabling facility may be designed to have a variety of different appearances, the appearance selected for the outside of the preferred embodiment of this disclosure of the invention is that of a castle 1000 as shown in FIG. 2. Other outside appearances such as a ranch or a building with a futuristic theme may also be used. When possible environmentally friendly construction techniques will be employed and environmentally friendly materials will be used. Energy efficiency may be obtained by the use of renewable energy resources such as solar panels on the roof of the castle 1000.

Underneath the castle 1000 shown in FIG. 2 is a secure parking facility, as shown in FIG. 2A 1050 for automobiles which may be entered through gate 1020 as shown in FIG. 2. The secure parking facility 1050 includes four separate areas 1100, 1200, 1300 and 1400, each corresponding to the four towers or modules 100, 200, 300 and 400 shown in FIG. 2. Each of the four separate parking areas includes a security gate 1120, 1220, 1320 and 1420 which may only be opened by the use of an authorized invitation issued by the enabling facility. In each of the four parking areas is an elevator 1130, 1230, 1330 and 1430 leading to a tower or module 100, 200, 300 and 400 respectively. By use of such a parking facility only those invited to a special event in a tower or module 100, 200, 300, 400 will be able to gain access only to the tower or module in which a special event is being held.

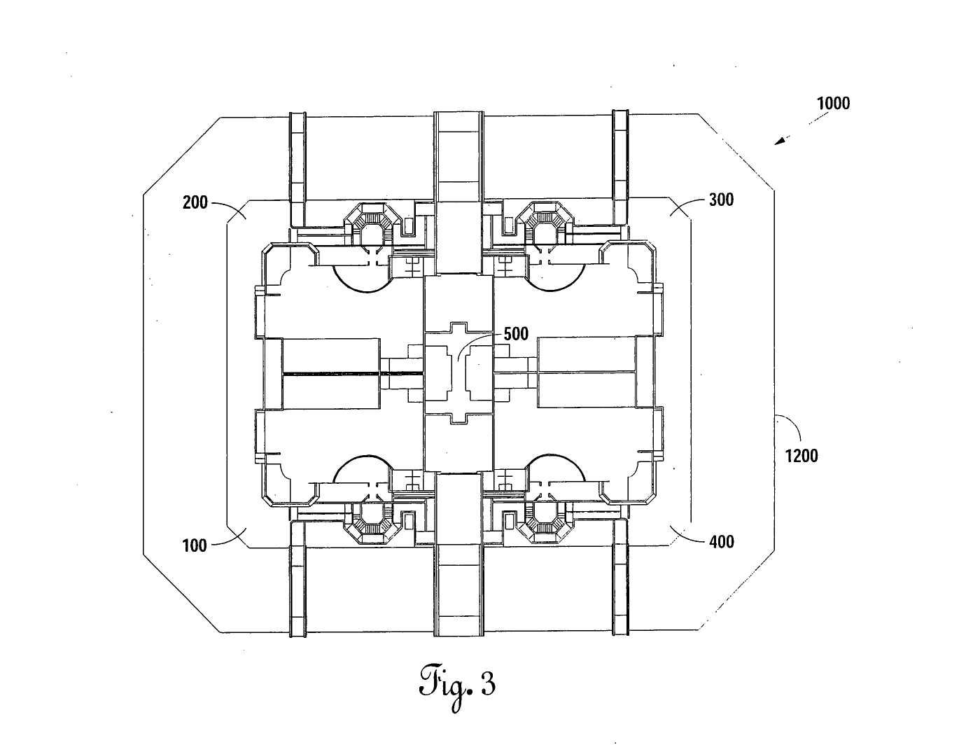

A floor plan of the preferred embodiment of the castle embodiment 1000 of the enabling facility appears in FIG. 3. While four modules or tower sections 100, 200, 300, 400 are shown in FIGS. 2 and 3, a single module or multiple modules may be included without departing from the scope of the present invention. Each module or tower section will be assigned an appropriate designator. The center 500 of the enabling facility 1000 is designed for housing the food preparation area and any administrative departments or offices that provide the services needed in each of the four modules or towers 100, 200, 300, 400.

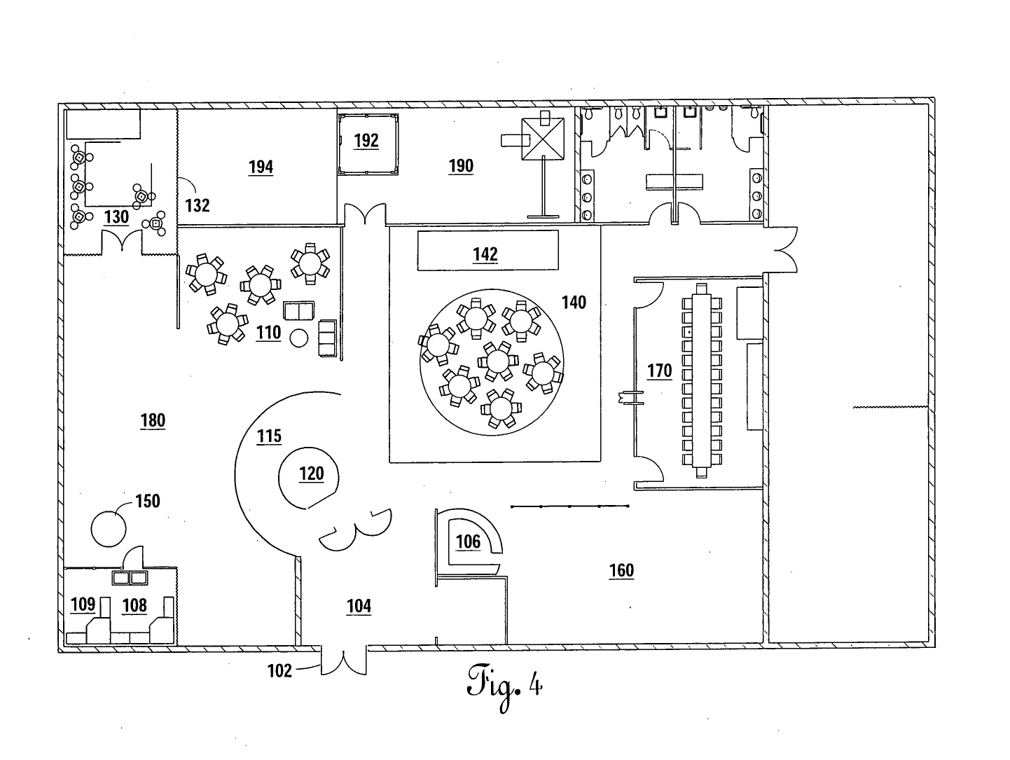

Each module or tower 100, 200, 300, 400 within the enabling facility 1000 provides a space for a different event. Accordingly, each module or tower 100, 200, 300, 400 will have its own activities, equipment, staff, parking lot, etc. The purpose of separating each module or tower 100, 200, 300, 400 is to separate and assure the security and privacy of the attendees at the special event. In the disclosed embodiment, four separate special events may be conducted at the same time, but each event will be private for its own group of attendees; however, if a single module or tower is used it will be necessary to include an administrative area and/or a kitchen and warehouse as shown in FIG. 4.

The disclosed castle embodiment 1000 of the enabling facility includes a wall 1200 built around therearound as shown in FIG. 3 for security. Attendees will begin their special event experience by having the feeling of entering a unique environment. The main entrance 1020 through which vehicles may drive down into the secured parking facility 1050 shown in FIG. 2A features a security gate 1022. Attendees dropped off enter each module or tower through a separate entrance, for example entrances 102 and 402 shown in FIG. 2. Those attendees must show an authorized invitation to the security personnel at an entrance security area to obtain entry. The security personnel manning the entrance security area will record identifying information such as the names of those people entering the module or tower and other important contact information which may be needed in the case of an emergency. The attendee and those accompanying the attendee will then be allowed to enter the module or tower 100, 200, 300, 400 for the special event to which the attendee has been invited. The purpose of these special steps is to make a record of the people who either enter and leave each module or tower.

As shown in FIG. 4 an exemplary floor plan of the single module or tower, once the attendees pass through the security area 104, the adults may proceed to an area 110 where they may sit or dine while the children take part in the special event. Within each module or tower 100, 200, 300, 400 are multiple activity areas where the staff of the enabling facility will make their presence known to the children, to the adults accompanying the children, and most of all to the sponsors of the special event. It is up to the sponsor of the special event which of the activity areas will be made available to the attendees of the special event.

A still better understanding of the disclosed invention may be obtained from a more detailed understanding of the floor plan of one of the modules of the enabling facility 1000 as provided in FIG. 4:

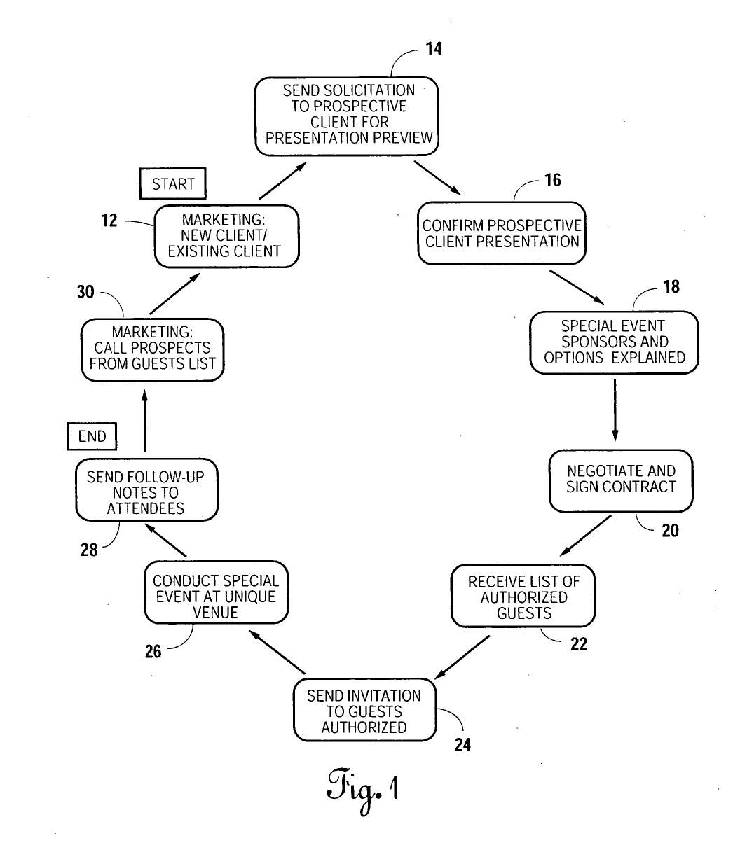

ENTRANCE. As described with respect to FIG. 2 each module or tower 100, 200, 300, 400 has its own entrance with its own entrance security area. At the entrance security area, 104 in FIG. 4, security personnel or a staff member will pick up the invitations which are the tickets to obtain entry to the module or tower to attend the special event. The invited children and accompanying adults will be identified. In addition, the adult responsible for taking each child home will be identified. This information will assist in identifying each child within the facility and facilitate calling each child by their given name. At the end of the special event it will then be possible to assure that each child leaves the special event with the properly designated adult. In the module or tower entrance security area 104, attendance at the event will be recorded for sending thank you notes to those attending the special event. This list of names can be used for marketing purposes as described below with respect to FIG. 1.

The central parent dining/sitting area 110 is the area around which the design of each module or tower is effectively centered. The central parent dining/sitting area 110 is created for the adults to have a comfortable place for observing the participants in the children and the special event. While the parents are in the central dining/sitting area 110, they will be able to see all areas of the or module or tower occupied by the children. The purpose of providing the central parent dining/sitting area 110 is that the parents are not going to be required to move about the module or tower looking for their children and worrying about their safety.

The central parent dining/sitting area 110 includes one or more TV screens to provide visual access to those parts of the module or tower not visible through the optional windows in the central parent dining/sitting area 110. The central parent dining/sitting area 110 is important because it enables one of the purposes of the disclosed invention, that is, to remove the concerns over child safety and special event management. If parents are relaxed they will be able to enjoy seeing their children have fun at the special event and may even be willing to participate in some of the activities with their children. Such parent participation promotes the parent-child relationship. The central parent dining/sitting area 110 can be designated as an optional service area for the attendees' use as a snack buffet area.

The signature event area 120 is the location for the signature portion of the special event such as the cutting of a birthday cake. The signature event area 120 is positioned to be in full view of the central parent dining/sitting area 110. Dramatic lighting effects and special interior treatments will be emphasized in the signature event area 120 to make it distinguishable from the other areas in each module or tower. The decor within the signature event area 120 emphasizes the feeling of being the center of attention for the child who is being honored at the special event. This makes the child's special moment a magical experience that will become a long term pleasant memory. By using music, lighting, special effects, and scenery along with an innovative way of cutting a cake, presenting an award or a religious memento such as a Holy Bible, the signature portion of the special event will be transformed into an extraordinary celebration remembered by all participants.

The audio isolation area 130 is where the attendees may enjoy one or more of a variety of noisy activities requiring audio isolation such as a piñata break, dancing and/or a karaoke event. The music will be appropriate for the ages of the event attendees. Sound protection 132 is provided for isolation of the noise made from the other areas. Children of all ages will be able to dance and/or sing in this area. This area 130 may be decorated as an adult disco, to make it attractive for older children who enjoy experiencing simulated adult activities.

The children's dining area 140 will be specially designed for the invited children to sit down and enjoy either a meal or a snack. A performance stage 142 will be included in this area. While the children are enjoying either a meal or snack, there will be age appropriate entertainment such as a puppet or magic show on the stage 142.

The indoor physical activity area 150 is designed for one or more designated physical activities where the children participate in a team or in a competitive activity. Team activities are chosen to reinforce the value that cooperation with others leads to the successful accomplishment of a goal. When there is inclement weather outside, the children will not be deprived of the chance to burn some energy in physical activities. Exemplary games and activities that may take place in this indoor physical activity area may include a climbing wall, a live maze, a tricycle track, a mini soccer field, etc.

TODDLERS' AREA. The toddler's area 160 is created for the use of children 1-4 years of age and the adults that accompany them. Here the toddlers will have the opportunity to play games or to enjoy, activities, appropriate for their age. Staff members designated to supervise activities just for the toddlers' area 160 will be made available during the event, so that the parents can be confident leaving a young child alone in the toddlers' area 160. The idea is that smaller children will be able to enjoy the special event in a safe and interesting place for their age. Access to the toddlers' area 160 is controlled to enable access by only smaller children as smaller children are the ones that are most vulnerable to being hurt by being in the way of the activities of the older children. Exemplary activities in the toddlers' area 160 may include, for example, a ball pool, a mini-classroom area, a mini hospital area, a mini supermarket area, a mini gym area, and a mini movie theater, etc.

The arts and crafts area 170 is where the children will use creativity to work with their hands and create something of their own. In the arts and crafts area 170 the children would be able to perform a variety of different art and/or craft activities selected from a plurality of age-appropriate art and craft activities. The idea behind the arts and crafts area 170 is to enable children of all ages to create something that is going to be for their own use or for which they can announce to their parents—“I made it myself.”

The video games and rides 180 will be near the parent dining/sitting area 110 for the children to ride and play video games at any time during the special event. Alternatively, a parent may want to enjoy a video game during the special event.

1. The video games and ride area 180 is provided because there will be children who will not want or be able to participate in all activities. Here another form of entertainment will be provided.

2. A variety of age appropriate video games will be made available.

3. Some exemplary of the other activities that can be located in the video games and ride area 180 include: a mini carousel, a mini bowling table, a basketball game for small children, a mini train etc.

Also near the parent dining/sitting area 110 but suspended over one or more of the other activity areas is an indoor playground area (not shown). The indoor playground area may include a variety of different types of apparatus for physical activity such as a tunnel with a four seasons theme so when the kids enter the area with the help of specially designed lighting and interior treatments, they can experience the four seasons of the year.

In addition to the indoor activities described above but within wall 600 is an outdoor apparatus and yard area 190 where outdoor play apparatus and game venues will be located. For example: outdoor play apparatus may include a playhouse, swings, slides, sandbox, and a trampoline 192. Also included in area 190 is a yard space 194 for games or sports activity.

1. The apparatus area and yard space together makeup is an outside playground area 190, because it is important that children experiment with activity in different environments, sceneries.

2. Not all children will want to participate in all of the indoor activities. The outdoor area 190 provides another option for entertainment.

The indoor open area 115 is between the adult dining/sitting area 110 and the signature event area 120. Herein, the children will see the pre-event welcome show. The indoor open area 115 provides an open space for inside running and free play. This area 115 can also be used for seasonal shows and activities. Such seasonal shows and activities will be an option from which the event sponsors can choose. The seasonal shows and activities can be changed to meet the preferences of the children.

One example of an activity for the indoor open area 115 would be a spa party for the girls. The open space area 115 would be decorated to resemble a day spa. Hair, nails, make-up will be done as if the girls were at their mother's spa. Another preparation theme for the indoor activity area 115 may be a small city. The children will dress in costume and be given clues to solve a mystery or accomplish a mission within the small city.

Support areas not designed for play or activities include those described in the following paragraphs:

The favor/prize area 106 will be near the entrance security area 104 so the children can pick up bags of favors and/or prizes at the end of the party or event.

1. This favor/prize area 106 is important because the children will see what their bag of favors/prizes is going to look like, and also the prizes for any contests that they will participate in during the event.

2. For girls the favor/prize may be a handbag that can be used for fashion accessories. For the boys the favor/prize may be a backpack or a themed cap.

3. Favors/prizes will change periodically. Children attending multiple special events at the enabling facility will be able to make collections of favors/prizes.

The security area 108 will be access restricted to only authorized personnel. Control and recording equipment for the closed circuit camera system will be located in this area.

1. The security area 108 provides the children safety which brings peace of mind to the parents.

2. Images recorded by the closed circuit security cameras will be monitored by the staff in the security area 108 to assure that all activities are being properly supervised.

3. A cot and first aid equipment will be made available in case of minor injuries.

The video/photos area 109 will be restricted to only authorized personnel. Here the staff will make and edit video and photos of the special event for the participants. A simple video format, for example a video format based on a TV Game Show, can be used to record the special event. A set of still photos may also be provided to the attendees as opposed to a video to remember the special event and show to other children at school or church.

It will be understood that an essential element of the present invention is the program offered to the attendees at the special event enabled by the staff of the enabling facility. This program is selected by the sponsors of the event as shown in the description of the business method below. It is the sponsors and/or the enabling facility who will determine which of the activities in the activity area are to be used and how these areas are to be used. Further, it is the sponsors who will select the theme of the special event and the type of food to be served. With these selections, the staff of the enabling facility will take over to create and implement the program offered to the attendees at the special event so that all attendees remain active and interested as they are guided to and encouraged to participate in the various activities offered by the enabling facility. Thus, the sponsors and those accompanying the attendees to the special event are relieved from the burden of assuring that the attendees remain active and interested and instead are free to share in the enjoyment experienced by the attendees to the special event. The attention to security and safety at the beginning, during the progress of, and at the end of the special event by the staff of the enabling facility further reduces a burden on the sponsors or those accompanying the attendees to the special event. An exemplary staff for the enabling facility is described includes:

SECURITY: Security guards

SET-UP/CLEANING: The people that are going to be setting up and then cleaning the enabling facility to assure its readiness for a special event.

WAITERS/BUSSERS: The people are going to be serving both the adults area and the children in their respective dining areas. Also the waiters are going to provide drinks for the children when they are thirsty. Throughout the special event the soiled plates, utensils and cups will be cleared away.

CHEF: The chef will be responsible for planning and preparing the meals or snacks and the presentation of the prepared food.

JOKER: This character will be the one telling jokes or funny stories to the people at the time of the event. The joker is also a key part of the security team. Funny antics and jokes will be told while observing the activities going on at the special event.

EVENT COORDINATOR(S): The event coordinator(s) are the people that are going to introduce the activities selected by the sponsors to the attendees and guide the attendees to the selected activities. The event coordinator(s) will be in contact with the attendees during the special event.

ASSISTANTS TO THE EVENT COORDINATOR(S): The assistants to the event coordinator(s) are the people that are going to be located in various areas of the enabling facility providing assistance to prepare activities for participation by the attendees and assist in the supervision of selected activities where needed.

Each event may be presented in a format similar to the format of a show. A script is provided for the staff. Most of the staff will participate generally as scripted for the special event. The staff will be trained to improvise, as needed, to respond to the children. For example, if one child is shy and appears to not want to participate in the selected activities, a staff member may use a story or simply hold the child's hand to introduce other areas of the enabling facility to the child to encourage participation. The purpose is for all children attending the special event to enjoy the experience. The use of a script enables the staff to know what to do, what kind of jokes or stories to tell with the different ages of children, or what attitude should be adopted in specific circumstances. The script will structure the conduct of the special event. The script will be designed for the different ages of the children and the characteristics of each age. The staff will be well trained to manage different personality types and any special situations that may arise.

The business method 10 of the present invention is described in FIG. 1. The business method 10 begins by marketing 12 the advantages and features described above to potential clients and repeat clients using a variety of different methods to include direct mailing 14. Those responding will receive additional information. Once a potential event sponsor decides to look into the advantages and features described above, a meeting will be scheduled and confirmed 16 to both explain the unique aspects of the enabling facility and present a demonstrative video of prior special events 18. At the presentation 18 to the potential event sponsors, available options for the special event will be explained. Once the special event date is confirmed, options are selected. Such options may include a menu and a theme costumes for the staff guiding the attendees of the special event. For example, theme costumes for the event coordinator(s) may include:

Princess Ballerina—Girl

Pop Dancing Star—Boy

Sport Queen—Girl

Sport King—Boy

Jungle Adventure—Girl

Jungle Adventure—Boy

Secret Service Commander—Girl

Secret Service Commander—Boy

Silly—Girl

Silly—Boy

The additional services provided by the administrative staff at the enabling facility will include invitation design, invitation preparation, invitation mailing, sending of thank you notes, planning, decorations, catering, shows, games, coordination of the event, prizes, favor bags, video and photos of the event.

All the activities to include prizes that are going to be given and play at every area will be chosen by the sponsors of the special event and listed in a contract and agreed to by the sponsors of the special event. The contract will include a variety of different payment options. Once the contract is signed 20, the sponsors will provide a list of approved attendees 22 and the invitations will be sent out 24.

Pre event planning begins with confirming with the sponsors the list of authorized guests who have indicated their plans to attend the special event.

The special event is then conducted 26. Following the special event a follow-up note is sent to each attendee 28. The attendees will receive future marketing materials 30 announcing changes or new offerings by the enabling facility 1000.

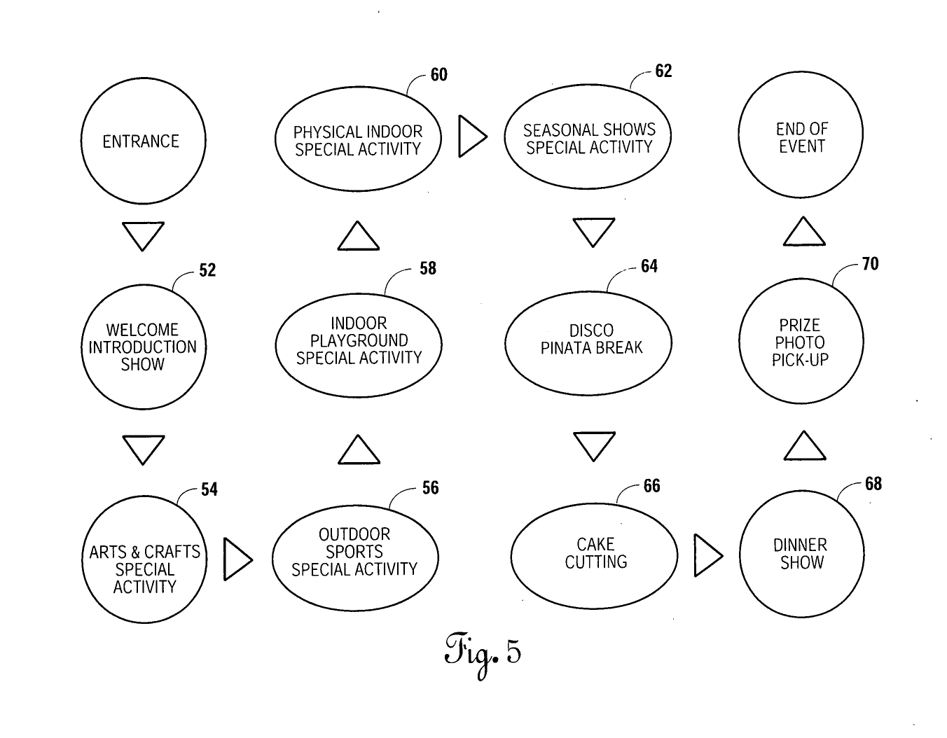

A still better understanding of the present invention may be had by a description of the sequence of events at an exemplary special event such as a birthday party. The following paragraphs together with FIG. 5 describe an exemplary birthday party.

The pre-program introductory show 52 is a brief overview of the group of activities, games and/or shows contracted for by the sponsors put together according to a time schedule that has been established for each party or event. Children will be introduced to the available entertainment and activities planned for the special event.

In the preferred embodiment, the special event will include as many as 7 activities of about 25 minutes each. After the activities there will be a signature event activity 66 such as cake cutting. A meal or snack may be served at this time. While the attendees are eating, age appropriate entertainment 68 will take place. This schedule will be specified on the invitations so the children will know ahead of time when and where the activities will take place as described below.

The pre-event welcome introductory activity 52 is in a designated area where the coordinator(s) of the event will be waiting for the children and adults to pass through the entrance security area 104 before moving the children into the open area 115. In the open area 115 there will be activities such as face painting, balloon figures, music together with an explanation of the guidelines associated with each activity during the upcoming special event. Adults will be directed to the dining/sitting area 110. The introductory activity 52 will include activities such as dance, a light show, or acrobatics to present the various staff members that are going to be interacting with the attendees of the special event and a presentation of the child or children being honored at the special event.

In the arts and crafts area 170 the children will participate in one or more of a variety of activities 54 such as painting pottery or making a stuffed animal, a hat, a bag, etc.

In the outdoor spots activities area 190 a sports or a game 56 will be made available.

In the indoor physical activity area 150 attendees will participate in a themed special activity 60 that will allow children to perform some type of activity such as going through a tunnel maze, climbing a wall, obtaining a prize and return to a home base.

In the indoor open area 115 seasonal activity 62 such as a spa party, or TV game show, etc. may be held.

In the audio isolation area 130, an event will be held such as a dance, a karaoke event or a piñata break 64. Dramatic effects lighting and modern rhythms can be used for accent.

In the signature event area 120 a feature event 66 will be held. Lights, popular music, and special effects will be used for accents to make this moment unique. The attendees will then be guided to the dining area 140 where they have a meal while being entertained with a magic or puppet show.

After dinner the children will have a free time to explore their favorite areas of the enabling facility until the special event is over.

Following the special event, favors and prizes are picked up 70.

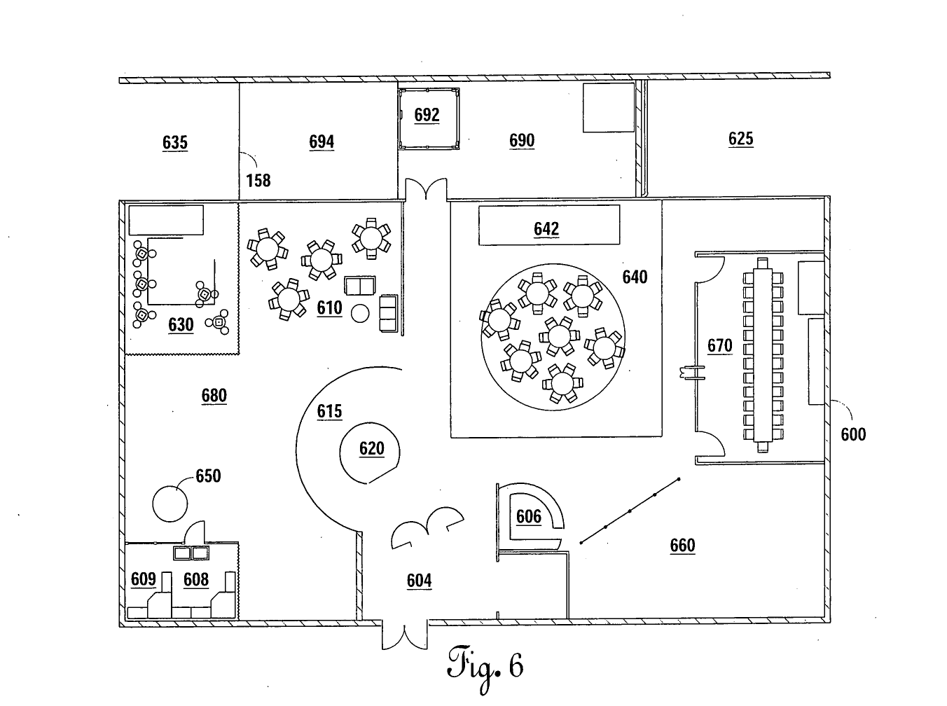

As indicated above, the first alternate embodiment of the business method and system centered on an enabling facility of the present invention is a mobile module 600 as shown in FIG. 6. Areas similar to those in the preferred embodiment bear the same reference number but for the number “6” in the hundreds place. The mobile module 600 will be for use in either parks, open areas, or residences having large, preferably grassy, areas. By use of the mobile module 600, the business method and system centered on an enabling facility of the present invention may be transported to a location selected by the user. Such transport may be by use of vans or trucks selected and packed for safe transport of the equipment shown in FIG. 6. If a plurality of fold out or expandable vans are used, the enabling facility can be located on the vehicles used for its transport. In other situations, a large tent or portable shelter may be set up so that the enabling facility is located within the tent or portable shelter.

By a comparison of the floor plan of the fixed enabling facility 100 shown in FIG. 4 to the floor plan of the mobile enabling facility 600 shown in FIG. 6, it will be seen that the arrangement of the activity areas on the two floor plans is essentially the same. What is different however is that the food preparation area 625 is mobile and will be set up adjacent to the activity areas. The outdoor area 690 is also adjacent to the activity areas. The equipment placed in this area will be transported along with the other equipment in the activity area. A mobile restroom facility 635 is also provided. The mobile restroom facility is set up adjacent to the activity areas. If needed, a mobile security fence may be used around the embodiment 600 shown in FIG. 6 if there is a chance of infiltration of the special event by those not invited to attend.

Maintained in the first alternate embodiment 600 of the present invention are the essential elements of the preferred embodiment. Specifically included is the parent dining/sitting area 610 which enables the parent and/or the sponsors of the event to observe those participating in the activities. Also included are the plurality of activity areas through which the attendees to a special event are guided by the enabling facility staff. Thus irrespective of the location of the enabling facility, the program enabled by the disclosed invention includes introducing and guiding the attendees through the activities selected by the sponsor of the special event held at the enabling facility. And, as shown in FIG. 6, the mobile module includes an entrance security area 604 and a security office 609 to assure security and safety for those who come to enjoy the special event. Those of ordinary skill in the art will understand that the first alternate embodiment may be used for un-sponsored activities which can be of a shorter duration than the special event described with respect to the preferred embodiment.

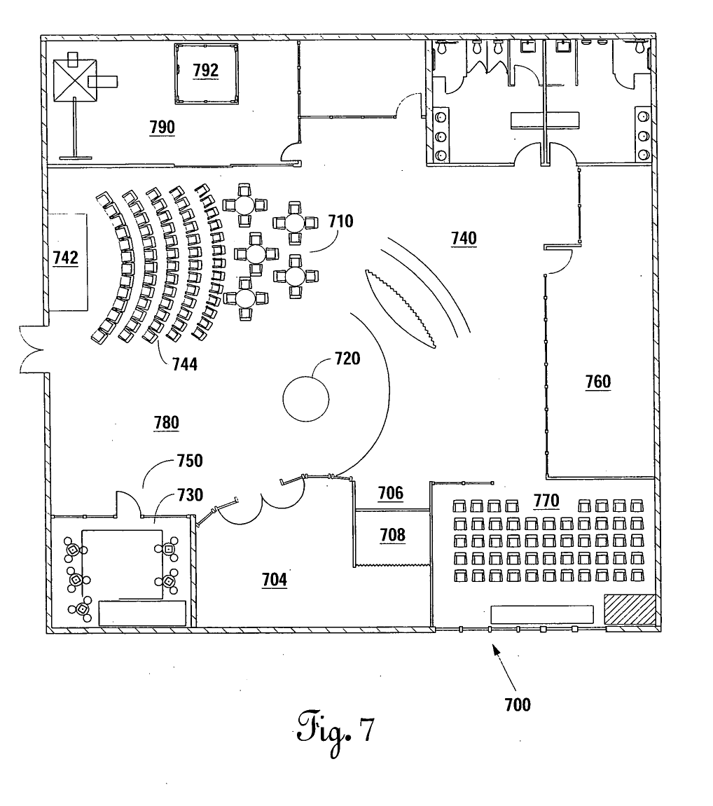

The second alternate embodiment is a down-sized embodiment 700 as shown in FIG. 7. The utility of the down-sized embodiment is in an area where either the market for special events or the available land will not permit the construction of a facility as large as the exemplary structure shown in the preferred embodiment. The utility of the down-sized embodiment may also be in a space of a predetermined size such as may be available in a shopping center where the enabling facility is placed in rented commercial space. Herein, the sponsors and/or those accompanying the attendees to the special event may remain at the special event in the adult dining/sitting area 710 or may engage in other activities and simply pick up the attendees to the special event when the special event is over.

As may be seen in FIG. 7 each of the sections of the activity area are smaller. Similar areas to those in the preferred embodiment have been given the same reference number but for the use of the number “7” in the hundreds place. Instead of an area for the serving of a meal, there is a snack bar area 740. In the area for the show on the stage 742, the area 744 in front of the stage includes theater style seats and the adjacent adult dining/sitting area 710 is smaller. The arts and crafts area 770 includes multiple small work stations as opposed to a long table as shown in FIG. 4.

As in the first alternate embodiment, the essential elements of the invention are included in the second alternate embodiment 700. Specifically, there is an adult dining/sitting area 710 in which those accompanying the attendees will be able to observe all activities while enjoying watching the happiness of those participating in the plurality of activities offered in the activity area. Further enabling the second embodiment is the program offered the attendees wherein the attendees will be introduced to and guided through the various activity areas and encouraged to participate. And, as in the preferred and first alternate embodiments, security and safety of the attendees remains a primary concern. Those of ordinary skill in the art will understand that the second alternate embodiment may be used for un-sponsored activities which can be of a shorter duration that the special event described with respect to the preferred embodiment.

In certain circumstances it may be possible to obtain the advantages of the present invention without a security system or with a security system substantially reduced from the security system described with respect to the preferred and alternate embodiments.

While the present invention has been disclosed by reference to its preferred and alternate embodiments, those of ordinary skill in the art will understand that numerous other embodiment have been enabled by the foregoing disclosure. Such other embodiments shall be included within the scope and meaning of the appended claims.

What is claimed is:

1. A system for providing a special event put on by one or more sponsors for a plurality of attendees, said system comprising:
means for enabling the one or more sponsors of the special event to select one or more activities from a plurality of activities for the special event;
a special event module including:
a central area in which the sponsors or those accompanying the attendees to the special event may observe the activities of the attendees to the special event;
an activity area including plurality of specialized activities areas available for selection by the one or more sponsors for inclusion in the special event;
a program enabled by a staff associated with said special event module to introduce and guide the attendees to the special event to the activities selected by the one or more sponsors of the special event;
a security system.

2. The system as defined in claim 1 wherein said central area includes windows and/or video surveillance equipment for observing the activities of all attendees to the special event.

3. The system as defined in claim 1 wherein said event module further includes a food preparation area.

4. The system as defined in claim 1 wherein said one or more specialized activity areas available for selection include: a signature event area; an audio isolation area, indoor physical activity area; a toddler activity area; an art/crafts area; a video game area; a rides area; an indoor playground area; an outdoor playground area; a prize/favor distribution area.

5. The system as defined in claim 1 wherein said security system includes one or more of the following: controlled access to the special event; controlled exit from the special event; closed circuit TV monitoring; special event staff trained in security; and specially trained security personnel.

6. The system as defined in claim 1 wherein said special event module is mobile to enable movement to a predetermined location.

7. The system as defined in claim 1 wherein said special event module if configurable for inclusion in an area of a predetermined size.

8. A business method for sponsoring and hosting a special event, said business method comprising the steps of:
selecting a list of activities from a predetermined list of activities available for the attendees to the special event;
providing an enabling facility for the special event, said enabling facility including:
an area for viewing the participants in the special event by those either sponsoring or accompanying the attendees to the special event;
one or more specialized activities selectable by the sponsors of the special event;
using a staff to conduct the special event, said staff introducing and guiding the attendees to the special event to the activities selected by the sponsors;
providing security for the special event.

9. The business method as defined in claim 8 wherein said area for viewing the participants includes windows and video surveillance equipment.

10. The business method as defined in claim 8 wherein said facility further includes a food service area.

11. The business method as defined in claim 8 wherein said one or more specialized activities are selected from a group including: a signature event, an audio isolation activity, indoor physical activity; toddler activities; arts/crafts; video games; rides; indoor playground; outdoor playground; and favor/prize distribution area.

12. The business method as defined in claim 8 wherein said step of providing security for the special event further includes one or more of the following:
controlled entry to the special event;
controlled egress from the special event;
closed circuit TV monitor of the special event;
staff personnel specially trained in security problem recognition and resolution;
security personnel specially trained in providing security in said facility.

13. The business method as defined in claim 8 wherein the enabling facility is mobile for movement to a predetermined location

14. The business method as defined in claim 8 wherein the enabling facility is configurable to inclusion in an area having a predetermined space

15. A module in which hosting a special event including a predetermined selection of activities may be offered to a sponsor of the special event and at which a program introducing and guiding the attendees to the special event is enabled, said module comprising:
a central area in which all of the activities of the attendees may be monitored by the sponsor or those accompanying the attendees to the special event;
a plurality of areas for the predetermined activities;
a security system.

16. The module as defined in claim 15 wherein said central area in which all of the activities of the attendees may be monitored further including windows and electronic video surveillance equipment.

17. The module as defined in claim 15 further including a food preparation area.

18. The module as defined in claim 15 wherein said specialized activities are selected from a group including one or more of the following activities: a signature event, an audio isolation event, indoor physical activity; toddler activities; art/crafts; video games; rides; indoor playground; outdoor playground; and favors/prize distribution.

19. The module as defined in claim 15 wherein said security system includes one or more of the following: controlled entry into the module; controlled exit from the module; closed circuit TV activity monitoring system; specially trained security personnel; special security training for staff members employed at the module.

20. The module as defined in claim 15 wherein said module is mobile for movement to a predetermined location.

21. The module as defined in claim 15 wherein said module is configurable for utilization in an existing structure.
